(19) United States
(12) Patent Application Publication
(10) Pub. No.: US 2012/0303429 A1
(43) Pub. Date: Nov. 29, 2012

(54) EMBEDDING AN OBJECT INTO AN ELECTRONIC MESSAGE AND OBTAINING CONTENT BASED THEREON

(75) Inventors: Nico Jose S. Nolledo, Makati City (PH); Mellissa B. Limcaoco, Makati City (PH)

(73) Assignee: Ion Cloud Technologies Corporation

(21) Appl. No.: 13/113,523

(22) Filed: May 23, 2011

(51) Int. Cl. G06Q 30/00; G06F 15/16; H04L 9/32

(52) U.S. Cl. 705/14.16; 705/14.39; 726/4; 705/14.73; 709/206

(57) ABSTRACT

Generating and embedding into a signature block of an electronic message a banner placeholder associated with an advertisement, sponsored or interactive content, coupon, deal, and/or other form of promotional banner. When a user receives the electronic message, the banner placeholder is configured to cause a browser to retrieve an advertisement, coupon, deal, and/or other form of promotional banner for display to the recipient of the electronic message in the signature block.

### BACKGROUND

The following description is provided to assist the understanding of the reader. None of the information provided is admitted to be prior art.

Many forms of advertising exist in today's marketplace. No matter the medium, the common goal is generally to persuade an audience to take some action with respect to a product, idea, or service. Most commonly, the desired result is to drive consumer behavior with respect to a commercial offering, although political and ideological advertising is also common.

Advertising messages are usually paid for by sponsors and viewed via various media, including traditional media such as newspapers, magazines, television, or radio, and more recently, media such as electronic messages. The emergence of electronic messages as an advertising platform, however, has created the ability for advertisers to send unsolicited bulk electronic messages indiscriminately. These electronic messages are commonly referred to as “spam,” and are most widely associated with email, but also applicable to mobile phone messaging, instant messaging, and the like. Advertisers use this form of advertising because it is economically viable due to minimal operating costs beyond the management of mailing lists. In the year 2011 alone, it is estimated that over seven trillion spam messages will be transmitted.

### SUMMARY

The Inventors have identified various shortcomings in connection with the current approach for advertising, and, in particular, advertising via electronic messages. For example, while electronic message marketing (e.g., spam) allows advertisers to send electronic messages to consumers at a minimal cost, the messages often have limited effectiveness because a large portion of the messages are automatically diverted to spam folders via filter applications. The messages that are not automatically diverted are usually not opened by the receiving party, or are classified as spam via a “report as spam” option. Hence, while numerous messages may be transmitted, the number of messages that are actually viewed by a receiving party is quite low.

In view of the foregoing, the Inventors have recognized and appreciated an efficient and effective technique for delivering electronic messages with advertisements, promotions, coupons, deals, offers, interactive content (e.g., polls, surveys, games, etc.) and sponsored content (e.g., video, audio, wallpapers, news, horoscopes, wallpapers, etc.) without being subject to filters and without irritating recipients. In particular, various inventive embodiments disclosed herein relate to methods, systems, devices, and software for embedding into a signature block of an electronic message a banner placeholder associated with an advertisement, sponsored or interactive content, coupon, deal and/or other form of promotional banner. When a user receives the electronic message, the dynamic advertisement, sponsored or interactive content, coupon, deal, and/or other form of promotional banner is displayed to the recipient in the signature block. If the sender sends, or the sender and/or recipient views, clicks, or does another required action (depending on the campaign mechanics) on the advertisement, sponsored or interactive content, coupon, deal and/or other form of promotional banner, the sending and/or receiving party may earn compensation and/or other rewards.

This form of advertising is far superior to the conventional advertising methods. In particular, by using peer-to-peer communication as opposed to bulk mail, a recipient is far more likely to view the advertisement, content, coupon, deal, and/or other form of promotional banner because it is associated with an electronic message from a known source (i.e., the sender of the electronic message). Moreover, by strategically locating the advertisement, content, coupon, deal, and/or other form of promotional banner in the signature block of the electronic message, the advertiser enjoys better visibility, as readers generally tend to view the signature line of an electronic message after reading the body of the electronic message. Furthermore, by providing an incentive to the sending party, more users are inclined to participate actively in an advertising campaign.

Hence, the Inventors have recognized and appreciated a novel technique for providing an advertisement, content, coupon, deal and/or other form of promotional banner which (i) takes advantage of peer-to-peer communication; (ii) maximizes visibility of the advertisement, content, coupon, deal, and/or other form of promotional banner by strategically displaying the advertisement, content, coupon, deal, and/or other form of promotional banner in the signature line of the electronic message; and/or (iii) provides an incentive for parties to actively participate in a campaign.

In sum, one embodiment of the present disclosure is directed to a system. The system comprises (i) a first server configured to deliver a webpage over a communication network in response to a request, wherein the webpage includes a banner placeholder configured to be copied or downloaded from the webpage; (ii) a first computing device configured to copy or download the banner placeholder from the webpage, modify one or more settings of an electronic messaging application such that the banner placeholder is automatically included within a signature block of an electronic message, and transmit the electronic message including the banner placeholder within the signature block of the electronic message to a second computing device; and (iii) a second computing device configured to receive and open the electronic message including the banner placeholder within the signature block of the electronic message, transmit a request for a file associated with the banner placeholder, and render content associated with the file in the signature block of the electronic message.

Another embodiment is directed to a method. The method comprises (i) accessing a website via a computing device communicating over a communication network, wherein the website is configured to provide a banner placeholder; (ii) copying or downloading the banner placeholder from the website, wherein the banner placeholder comprises one or more HTML tags that each reference content; (iii) modifying one or more settings associated with an electronic messaging application such that the banner placeholder is automatically included with a signature block of an electronic message; and (iv) transmitting the electronic message including the signature block with the banner placeholder included therein.

Another embodiment is directed to a method. The method comprises (i) providing a website over a communication network in response to a request; (ii) receiving authentication information entered on the website and determining if the authentication information is associated with an authorized user; (iii) and if the authentication information is associated with an authorized user, providing a banner placeholder, wherein the banner placeholder comprises one or more HTML tags that each reference content.

Another embodiment is directed to a non-transitory computer readable medium having instruction stored thereon, comprising (i) instructions for providing a website over a communication network in response to a request; (ii) instructions for receiving authentication information entered on the website and determining if the authentication information is associated with an authorized user; and (iii) instructions for, if the authentication information is associated with an authorized user, providing a banner placeholder, wherein the banner placeholder comprises one or more HTML tags that each reference content.

Another embodiment is directed to a method. The method comprising (i) receiving, at a server, a file request, wherein the file request includes a unique member identification obtained from a banner placeholder included within a signature block of an electronic message; (ii) determining, based on the unique member identification, an advertisement, content, coupon, deal, or promotion appropriate for the file request; and (iii) causing a file associated with the advertisement, content, coupon, deal, or promotion to be transmitted, wherein the file is rendered in the banner placeholder included within the signature block of the electronic message.

Another embodiment is directed to a non-transitory computer readable medium having instruction stored thereon, comprising (i) instructions for receiving a file request, wherein the file request includes a unique member identification obtained from a banner placeholder included within a signature block of an electronic message; (ii) instructions for determining, based on the unique member identification, an advertisement, content, coupon, deal, or promotion for the file request; and (iii) instructions for causing a file associated with the advertisement, content, coupon, deal, or promotion to be transmitted, wherein the file is rendered in the banner placeholder included within the signature block of the electronic message.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

The foregoing summary is illustrative only and is not intended to be in any way limiting. In addition to the illustrative aspects, embodiments, and features described above, further aspects, embodiments, and features will become apparent by reference to the following drawings and the detailed description.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the disclosure may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 is a block diagram illustrating an exemplary system for receiving, creating, and/or transmitting an electronic message with a placeholder banner embedded in an electronic message, according to one embodiment of the present disclosure.

FIG. 2 is a block diagram illustrating a general architecture for a computing system that may be employed to implement various elements (e.g., sub-systems) of the system shown in FIG. 1, according to one embodiment of the present disclosure.

FIG. 3 is a flow chart illustrating a method, according to one embodiment of the present disclosure, for retrieving, embedding, and/or transmitting a placeholder banner.

FIG. 4 is an exemplary electronic message, according to one embodiment of the present disclosure.

FIG. 5 is a flow chart illustrating a method, according to one embodiment of the present disclosure, for embedding a placeholder banner in an electronic message.

FIG. 6 is a flow chart illustrating a method for rendering a file associated with the electronic message, according to one embodiment of the present disclosure.

FIG. 7 is a flow chart illustrating a method, according to one embodiment of the present disclosure, for rending a webpage in response to a user selecting an advertisement, content, coupon, deal, and/or other form of promotional banner.

FIG. 8 is a flow chart illustrating a method for creating and/or registering a campaign with a service provider, according to one embodiment of the present disclosure.

### DETAILED DESCRIPTION

Following below are more detailed descriptions of various concepts related to, and embodiments of, inventive methods, systems, and software for embedding an object into an electronic signature and obtaining content based thereon. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

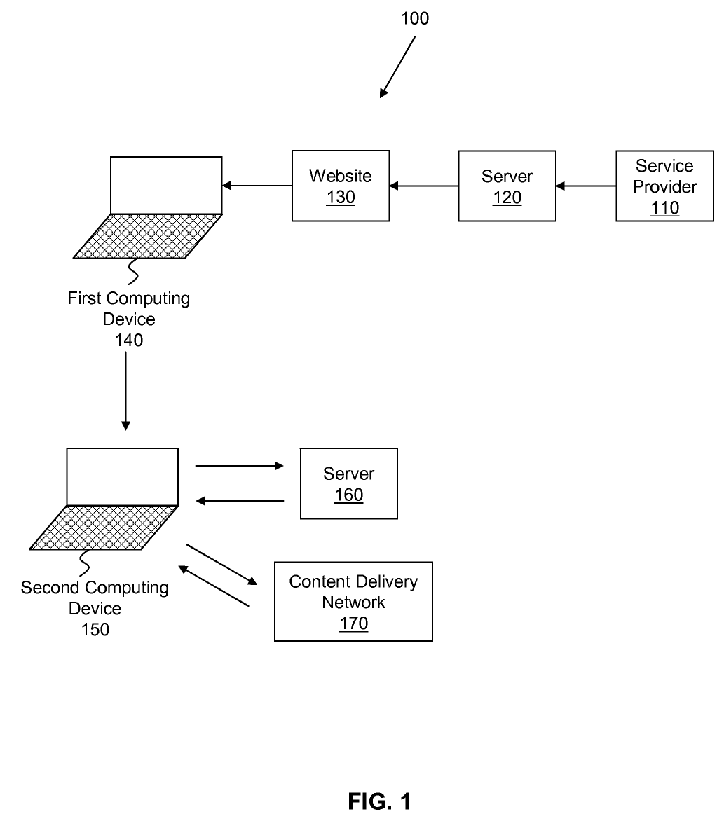

FIG. 1 illustrates an exemplary system 100 for receiving, creating, and/or transmitting an electronic message with a banner placeholder embedded in the electronic message. As mentioned above, this banner placeholder is associated with and configured to obtain/provide an advertisement, content, coupon, deal, and/or other forms of promotional banner. While the exemplary system 100 is discussed in greater detail below as embedding an advertisement banner into a signature block of an email message, it should be appreciated that the concepts disclosed herein are not limited in this respect, and may apply more generally to various types of banners (e.g., a coupon banner) and various types of messages (e.g., an instant message, a short message service (SMS) message, a multimedia message service (MMS) message, an instant message, a blog message, an audio message, a video message, a wall post, a status message, a comment on a site, a microblog message, a geolocation check-in message, a forum post, a forum private message, a social network private message, or the like.)

As illustrated, the system 100 may include a service provider 110, a first server 120, a first computing device 140, a second computing device 150, a second server 160, and/or a context delivery network 170. The service provider 110 may be an advertising entity, a marketing entity, an organization, an institution, a corporation, or the like associated with a website 130 provided by server 120. Server 120 may be a web server that includes hardware and/or software configured to deliver content that can be accessed through the Internet. Server 120 may host the website 130 associated with service provider 110 and provide associated web pages to a first computing device 140 upon request. In some embodiments, first computing device 140 and second computing device 150 may be one and the same computing device. In some embodiments, first server 120 and second server 160 may be one and the same server.

The first computing device 140 and/or second computing device 150 may be a personal computer (PC), laptop, smart phone, PDA, cellular phone, tablet PC, thin client, web television, iPhone, iPad, or the like. The first computing device 140 may be configured to receive content from server 120 via one or more communication networks including, but not limited to, a mobile telephone network, a wireless Local Area Network (LAN), a Bluetooth personal area network, a token ring LAN, a wide area network, an Ethernet LAN/WAN, the Internet, etc. The one or more communication networks may be wired and/or wireless. The first computing device 140 may be configured to communicate in accordance with various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, Long Term Evolution (LTE), etc. The first computing device 140 may communicate using various media including, but not limited to, radio, infrared, laser, cable connection, and the like.

In an illustrative embodiment, a user may use a web browser associated with the first computing device 140 to access a website 130 hosted by server 120 and associated with service provider 110. Once the first computing device 140 accesses the website 130, the user may conduct various processes (e.g., register, login, provide authentication data, provide email client information, provide browser information, provide computer capability/configuration information, etc.) on the website 130 in order to gain access and ultimately retrieve a banner placeholder.

The banner placeholder may be one of several mechanisms that provide for retrieving content from, e.g., a content management system or web server. The content may include a graphic, a segment of HTML or plain text, a file to be viewed with a plug-in, an advertisement, a coupon, an image file, eXtensible HyperText Markup Language (XHTML), shockwave files, or the like. The banner placeholder may contain one or more queries, and run a query and display the results of the query in the banner.

More precisely, the banner placeholder may be a set of HTML tags that reference content (e.g., advertising, coupon, deal, and/or promotional content). For example, an <img> tag may be used to display a banner image, and a <a> tag may be used to point to a particular landing page (e.g., an advertiser's landing page). An exemplary banner placeholder may therefore have the following general format:

<a href=“http://web.service.com/link-script.php?m=54bfc0cb4edb5335”

target=“_blank”>

<img src=“http://web.service.com/image-script.php?m=54bfc0cb4edb5335”

The <a> tag may include a reference to the advertiser's landing page, and the <img> tag may include a reference to a banner image. These references may both be formatted as hyperlinks or universal resource identifiers (URI), which may include the location of a server script and/or a query string parameter (e.g., m=54bfc0cb4edb5335).

With regard to the hyperlink or URI format, in some embodiments, a “.php” filename extension may be used. This identifies the script as a program written in the PHP language. In other embodiments, the filename extension may be hidden and the hyperlink or URI formatted so that the language used is unknown. For example, and with reference to the above example, the hyperlink in this embodiment may be:

http://web.service.com/image-script/m/54bfc0cb4edb5335

With regard to the query string parameter, this parameter (e.g., m=54bfc0cb4edb5335) may include an encrypted member identification. In the example above, “m” is used to indicate that Blowfish is used as the encryption algorithm. Blowfish is a symmetric block cipher with a 64-bit block size and 448-bit secret key. Other encryption algorithms may also be used in accordance with various embodiments.

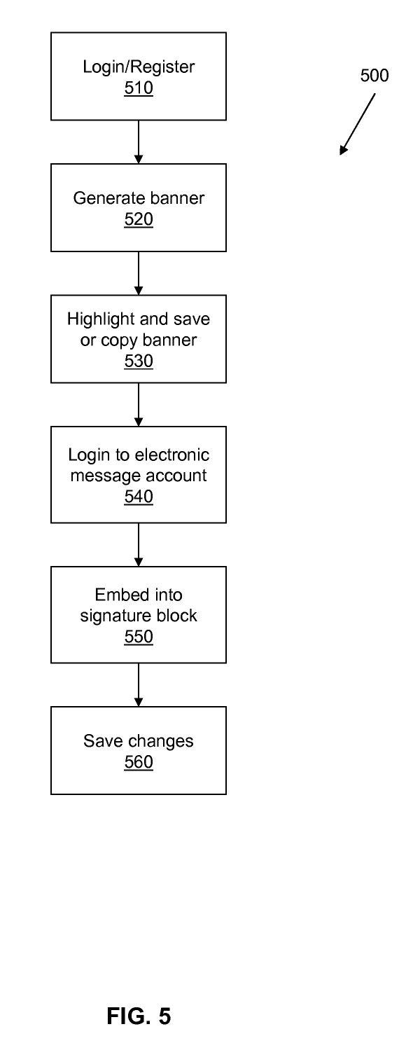

The member identification may be encrypted and embedded in the banner placeholder in response to a user or member joining the service (see, e.g., block 510 in FIG. 5). Each user or member may be assigned a single unique member identification for inclusion within their respective banner placeholder. Symmetric encryption may be used to hide the real value of the member identification, as well as for validating its value for the purpose of filtering valid clicks from invalid clicks.

It should be understood that the above is merely an example of a general format, and an actual banner placeholder may have additional formatting tags directed to, e.g., fonts, colors, margins, etc. Moreover, it should be understood that the above is an example specific to email messages. In the case of other types of messages, an <object>, <embed>, or other type of tag may be used. That is, a tag or protocol applicable to the specific type of message may be used.

Furthermore, it should be appreciated that the use of the above-mentioned HTML tags enables various restrictions associated with electronic messaging applications to be circumvented. For instance, due to email being the main source of viruses, worms, and trojan horses, electronic messaging applications often automatically delete HTML tags that allow for execution of potentially malicious scripts on the user's computing device. The above exemplary HTML tags, however, do not include scripts or programs that may be executed on the user's computing device. Instead, the HTML tags contain references to scripts that reside on and are executed on a server. Hence, the electronic messages including the banner placeholders commensurate with various embodiments of the present disclosure are not automatically deleted by electronic messaging applications.

As discussed in greater detail below, a user of the first computing device 140 may retrieve the above-mentioned banner placeholder by copying the banner placeholder via the copy function and/or by saving the banner to a location in memory. Alternatively, in some embodiments, the user may retrieve the banner placeholder via an email message originating from the service provider and including the banner placeholder. In either case, once the banner placeholder is received, the user may then access an email client or application (e.g., Gmail, Hotmail, Microsoft Outlook 2003, Microsoft Outlook 2007, Microsoft Outlook Express, Yahoo Mail, Apple Mail, AOL, Hotmail, Pegasus Mail, Mozilla Thunderbird, etc.) and navigate to the signature block settings. By using various techniques discussed in further detail below, the user may modify the signature block settings of the email client to include the banner placeholder. In some embodiments, this process need only occur once in order for all outgoing emails to automatically include the banner placeholder in the signature block. That is, of course, until the user modifies the settings at a later point to not include the banner placeholder.

Once the processes are complete, the first computing device 140 may transmit email messages with the banner placeholder included in the signature block of the messages. For example, the first computing device 140 may create and transmit an email message to a second computing device 150 via one or more of the same communications networks described above and via one or more of the same communication techniques and mediums described above. The second computing device 150 may receive and open the email message via an email client or application associated therewith (e.g., Gmail, Hotmail, Microsoft Outlook 2003, Microsoft Outlook 2007, Microsoft Outlook Express, Yahoo Mail, Apple Mail, AOL, Hotmail, Pegasus Mail, Mozilla Thunderbird, etc.). As mentioned, the email message includes the above-discussed banner placeholder in the signature block, which may be configured to automatically retrieve, e.g., an advertisement, promotion, deal, and/or coupon for display therein from server 160 and/or content deliver network 170. Server 160 may be, e.g., a web server. Content delivery network 170 may be, e.g., a system of computers containing copies of data placed at various nodes of a network.

As described in further detail below, the sender and/or receiver of the email may receive compensation or rewards for: sending or sharing the email; receiving the email; printing the email; selecting the advertisement, content, coupon, deal, and/or other form of promotional banner displayed in the banner placeholder; purchasing products or services on a webpage associated with the advertisement, content, coupon, deal, and/or other form of promotional banner; conducting a required action by the advertisement, content, coupon, deal, and/or other form of promotional banner; and/or printing portions of a webpage associated with the advertisement, content, coupon, deal, and/or other form of promotional banner.

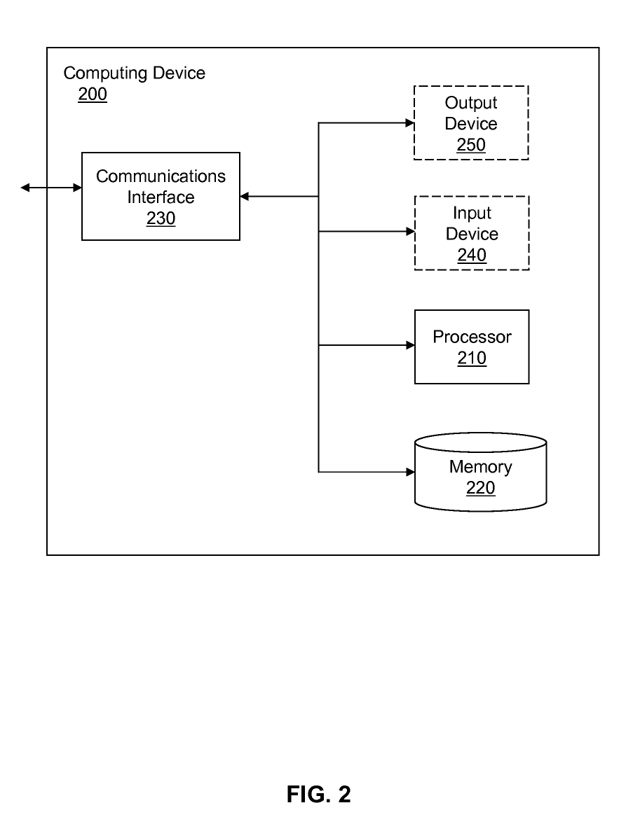

FIG. 2 shows the general architecture of an illustrative computer system 200 that may be employed to implement any of the computer systems discussed herein (including one or more of the first server 120, the first computing device 140, the second computing device 150, the second server 160, and/or the content delivery network 170, as shown in FIG. 1) in accordance with some embodiments. The computer system 200 of FIG. 2 comprises one or more processors 202 communicatively coupled to memory 204, one or more communications interfaces 206, and optionally one or more output devices 210 (e.g., one or more display units) and one or more input devices 208.

In the computer system 200 of FIG. 2, the memory 204 may comprise any computer-readable storage media, and may store computer instructions (also referred to herein as “instructions” or “processor-executable instructions”) for implementing the various functionalities described herein for respective systems, as well as any data relating thereto, generated thereby, and/or received via the communications interface(s) or input device(s) (if present). The processor(s) 202 shown in FIG. 2 may be used to execute instructions stored in the memory 204 and, in so doing, also may read from or write to the memory various information processed and or generated pursuant to execution of the instructions.

The processor 202 of the computer system 200 shown in FIG. 2 also may be communicatively coupled to and/or control the communication interface(s) 206 to transmit and/or receive various information pursuant to execution of instructions. In particular, the communications interface(s) 206 may be coupled to a wired or wireless network, bus, or other communication means and may therefore allow the computer system 200 to transmit information to and/or receive information from other devices (e.g., other computer systems). In some implementations, the communications interface(s) may be configured (e.g., via various hardware components and/or software components) to provide a website as an access portal to at least some aspects of the computer system 200. In this respect, referring again to the system 100 of FIG. 1, examples of communications interfaces include the website 130.

The optional output devices 210 of the computer system 200 shown in FIG. 2 may be provided, for example, to allow various information to be viewed or otherwise perceived in connection with execution of the instructions. The optional input device(s) 208 may be provided, for example, to allow a user to make manual adjustments, make selections, enter data or various other information, and/or interact in any of a variety of manners with the processor during execution of the instructions. Additional information relating to a general computer system architecture that may be employed for various systems discussed herein is provided at the conclusion of this disclosure.

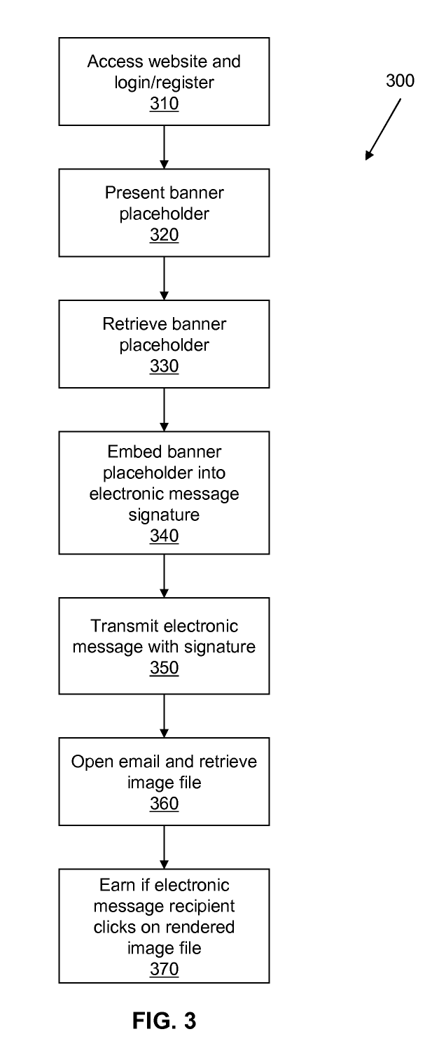

FIG. 3 provides an overview of a method 300 according to one embodiment. With reference to both FIG. 1 and FIG. 3, in block 310, a user accesses a website 130 associated with service provider 110 and provided by server 120. A webpage associated with the website 130 is displayed on a display associated with first computing device 140. This webpage may be a homepage of the website 130. Through this webpage, the user may login via known authentication and/or authorization processes. If the user is a new customer, the user may register by providing personal and/or business information (e.g., name, address, credit card information, billing information, type(s) of electronic messaging application, etc.). Once the user is logs-in or registers, the user may be presented with additional options via the same or another webpage associated with the website 130. One option may be retrieve, copy, generate, and/or save a banner placeholder. This banner placeholder may be customized or configured for a particular electronic messaging application. Thus, the user may be requested at this point or an earlier point to provide identifying information about an electronic messaging application. For example, the user may be required to input information about the type of messaging (e.g., email, MMS, SMS, instant messaging, etc.), as well as information about the particular electronic messaging application (e.g., Gmail, Hotmail, Microsoft Outlook 2003, Microsoft Outlook 2007, Microsoft Outlook Express, Yahoo Mail, Apple Mail, AOL, Hotmail, Pegasus Mail, Mozilla Thunderbird, etc.). Based at least on this information, at block 320, the user may be presented a banner placeholder to copy and/or save. As mentioned above, the banner placeholder may be delivered via means other than the website—e.g., via an email message. As further mentioned above, the banner placeholder may be one of several mechanisms that provide for retrieving content from, e.g., a content management system or web server. The banner placeholder may be a set of html tags referencing content, and the content may a graphic, a segment of HTML or plain text, a file to be viewed with a plug-in, an advertisement, a coupon, an image file, eXtensible HyperText Markup Language (XHTML), shockwave files, or the like. The banner placeholder may contain one or more queries, and run a query and display the results of the query in the banner.

At block 330, the user may retrieve the banner placeholder. As discussed in more detail with respect to FIG. 5, this may be accomplished by highlighting the banner placeholder and using the “copying” function. That is, the user may highlight the banner placeholder and, e.g., press Ctrl+C (for PC users) or Cmd+C (for Mac users) and copy the banner placeholder. Alternatively, the user may right-click and select the “copy” option, or use any other copying option available on the first computing device 140. Alternatively, the user may save a file associated with the banner placeholder to memory. When saving, the user may use a .html extension name. In addition, the user may select “webpage HTML only” under the Save-As Type. Alternatively, the user may download the banner placeholder by downloading a browser extension or plug-in.

Once the banner placeholder is retrieved from the webpage, at block 340, the user may embed or otherwise place the banner placeholder into one or more signature blocks of an electronic messaging application. This process is described in greater detail with respect to FIG. 5, but generally involves accessing various setting options with respect to the electronic messaging application and uploading, pasting, or otherwise inserting the banner placeholder into a portion of the signature block setting. The modified signature block may then be saved.

At block 350, the user may transmit an electronic message from the first computing device 140 to a second computing device 150 via one or more communication networks. It should be understood that the first computing device 140 may alternatively transmit the electronic message to a plurality of second computing devices.

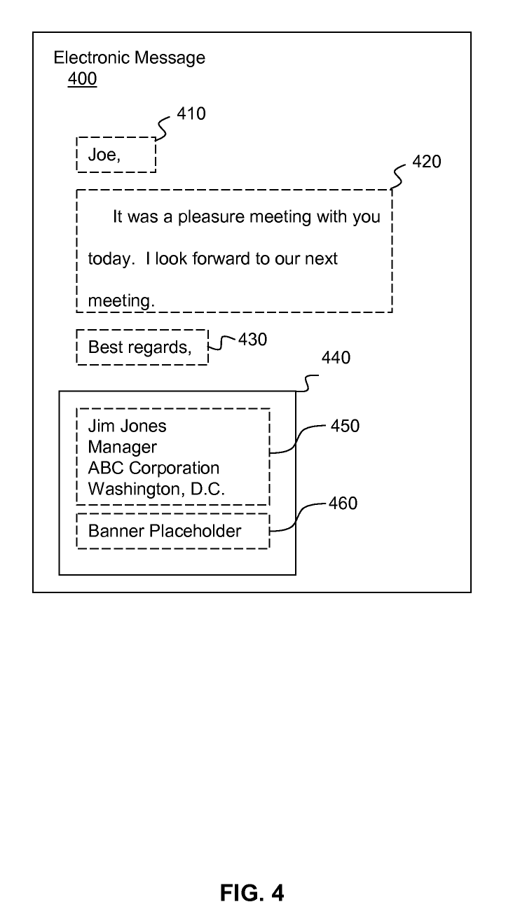

As further discussed with regard to FIG. 4, the electronic message includes a signature block with, e.g., a valediction (e.g., “Thanks,” “Best Regards,” “Sincerely, etc.), a name, an address, and/or the banner placeholder.

Upon reception of this electronic message, at block 360, the recipient may open the electronic message via an electronic messaging application. The electronic message may display a dynamically generated advertisement or coupon in the banner placeholder. If the user selects or clicks on the advertisement or coupon, the user who sent the electronic message, at block 370, may receive a reward, compensation, or other incentive. In some embodiments, the user who sent the electronic message may receive the incentive simply by sending or sharing the electronic message or simply in response to the recipient opening the electronic message. In other embodiments, the sender and/or receiver may receive the incentive if sender and/or receiver shares, views, clicks or does another required action on the advertisement, sponsored or interactive content, coupon, deal, and/or other form of promotional banner.

FIG. 4 is an exemplary electronic message 400, according to one embodiment of the present disclosure. As described above, this electronic message may be an email, MMS, SMS, instant message, or any other type of message where there is a signature block. As illustrated, the electronic message 400 may include a salutation 410, a textual body 420, and a valediction 430. In addition, the electronic message may include a signature block 440. This block may include a signature or name with company information 450 (e.g., “Jim Jones, Manager, ABC Corporation, Washington D.C.”). Associated therewith may be the banner placeholder 460. This banner placeholder 460 may be located anywhere within the signature block. For example, the banner placeholder 450 may be located below, above, or within the elements depicted in block 450. In addition, in some embodiments, the banner placeholder 460 may be the only element within the signature block 440. Furthermore, in some embodiments, the signature block may comprise more than one banner placeholder.

FIG. 5 is a flow chart generally illustrating a method for embedding a banner in an electronic message, according to one embodiment. At block 510, a user logs-in or registers with the website associated with the service provider. At block 520, the user causes a banner placeholder to be generated, or is otherwise presented with a banner placeholder. At block 530, the user copies or otherwise saves the banner placeholder to memory. At block 540, the user logs-in or opens an electronic message application. At block 550, the user embeds the banner placeholder into a signature block via a setting adjustment. At block 560, the user saves this new setting.

The processes described in FIG. 5 may vary depending on the type of electronic messaging application. That is, the process may vary depending on whether the user uses, e.g., Gmail, Hotmail, Microsoft Outlook, Outlook Express, Yahoo Mail, Apple Mail, AOL, etc. Moreover, the processes may vary depending on the type of browser, e.g., Google Chrome, Mozilla, Firefox, Safari, etc. In a representative embodiment, the embedding process may comprise one or more of the following processes:

(a) log-in/register with website;

(b) generate, receive, and/or view banner placeholder;

(c) highlight banner placeholder;

(d) copy or save the banner placeholder;

(e) login to email account;

(f) navigate to “settings” option;

(g) navigate to “signature” modification/creation option;

(i) paste or upload the signature banner into the signature field; and/or

(j) select “save changes.”

For some browsers, security settings may require modification. For example, the “display mixed content” option may have to be activated. Furthermore, for some electronic messaging applications (e.g., Microsoft Outlook Express), the banner placeholder may be saved with a .html extension.

It should be understood that the above-mentioned processes, applications, and browsers are merely exemplary, and other types of browsers, applications, and/or processes may be used in conjunction with various embodiments of the present disclosure. Moreover, processes may be conducted in a different order than described.

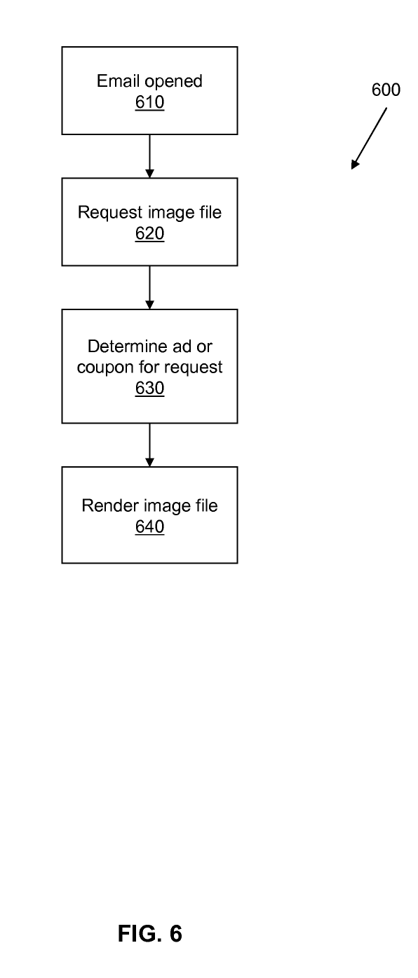

FIG. 6 is a flow chart generally describing processes 600 for rendering content associated with the banner placeholder at the second computing device 160 (i.e., the recipient's computing device), in accordance with one embodiment. The process begins when an electronic message is received via one or more communication networks at the second computing device 160. The electronic message may be provided to a user of the second computing device via an electronic messaging application. In particular, a user may login to an electronic messaging application and open the electronic message received from the first computing device 150. As described above and illustrated in FIG. 4, the electronic message may include a banner placeholder within the signature block of the electronic message. When the electronic message with the banner placeholder is opened, at block 610, the banner placeholder may cause the browser or electronic messaging application to “fetch” a file from a server. The file may be an image file, a segment of HTML, plain text, or a file to be viewed with a plug-in. Moreover, the file may comprise an advertisement, content, coupon, deal, and/or other form of promotional banner.

The server, upon receiving a request provided by the browser or electronic messaging application at block 620, may identify the user who embedded the banner placeholder via a unique member identification (hereinafter “Member ID”) associated with the banner placeholder and transmitted by the browser. This may be accomplished by decrypting the Member ID associated with, e.g., a hyperlink of the banner placeholder. This Member ID may then be validated against a list of valid values stored in the server. If the Member ID is not found, the server may consider the request invalid and redirect the request to a default image banner (e.g., an invisible pixel, a marketing banner designed to promote the banner service, etc.).

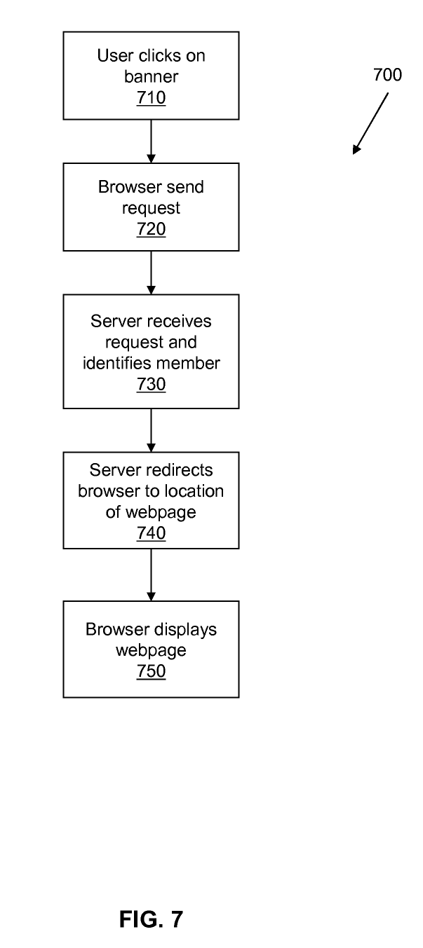

The server may further identify the recipient of the electronic message by checking if a unique identifier associated with the second computing device is saved. If a unique identifier associated with the second computing device is not saved, the server may generate a new unique identifier for the second computing device for, e.g., potential compensation or reward purposes. This unique identifier for the second computing device (hereinafter “Visitor ID”) may be encrypted in the same manner as described above with respect to the Member ID that was embedded in the banner placeholder. A copy of the Visitor ID may be saved in the server and used in, e.g., a validation processes when the email recipient clicks on the advertisement, content, coupon, deal, and/or other form of promotional banner (see, e.g., block 730 in FIG. 7).

Furthermore, an Internet Protocol (IP) address of the second computing device may be recorded. In some embodiments, the server may limit the number of unique Visitor ID's that are generated and saved with respect to the second computing device for the purpose of detecting duplicate or invalid ad impressions and clicks. If the number of unique visitors that are associated with an IP address exceed a threshold number, the request may not be counted as a valid ad impression.

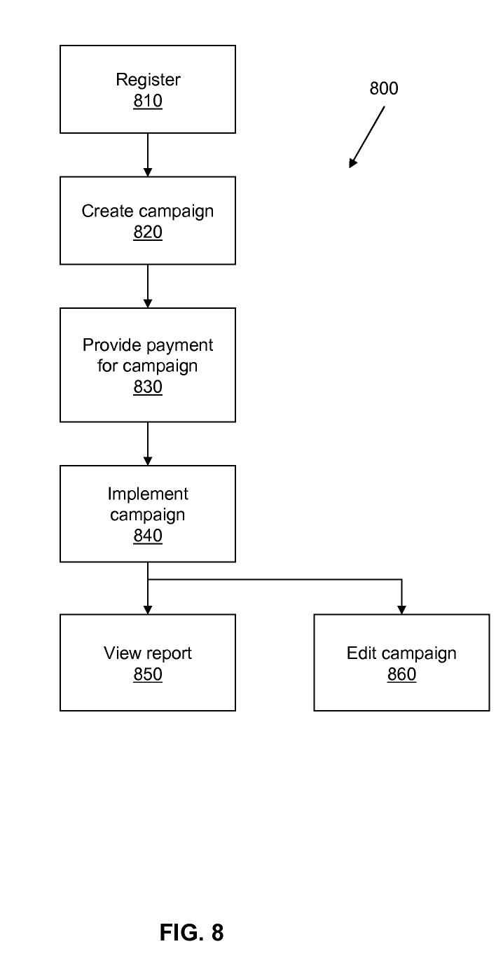

The server may also identify the country location of the second computing device using a geolocation database. The server may count a request as a valid ad impression only if the country is identified as one of the target locations for this advertisement, content, coupon, deal, and/or other form of promotional banner. The target locations may identified by the advertiser in a campaign creation process (see, e.g., block 820 in FIG. 8).

In some embodiments, the server may identify the browser, electronic messaging client, platform, and/or service that the electronic message recipient is using to open the electronic message. If the server determines that such information is invalid (e.g., when the software that is used to retrieve the banner is a script, a bot, or a benchmarking tool), the server may not log the request as a valid ad impression. If valid, however, the server may record the request and determine if the electronic message recipient identified by the Visitor ID has previously downloaded the advertisement, content, coupon, deal and other forms of promotional banner. The server may count unique ad impressions only—i.e., if the recipient has previously downloaded the advertisement, content, coupon, deal and other forms of promotional banner, it is not counted as a valid ad impression.

The server may further determine, in some embodiments, if the first computing device is the same as the second computing device by generating and saving a unique identifier in the first computing device at the time the member logs in to the service. If the unique identifier is found on the second computing device, it is assumed that the person who embedded the placeholder is the same person who is viewing the banner image (such as the case when the member is composing or reading his own email). Thus, the request is not counted as an ad impression.

Continuing with FIG. 6, at block 630, the server may determine an appropriate file for the request. This process may involve the server determining that an advertisement, content, coupon, deal, and/or other form of promotional banner is currently matched to a member based on the unique Member ID. Moreover, one or more filters may be applied to verify the validity of the request. The server may then redirect the request to a location of the file on a web server or content delivery network, and the web server or content delivery network may provide the file to the browser and/or electronic messaging application associated with the second computing device 160 (i.e., the recipient's computing device).

More specifically, in some embodiments, advertisements, content, coupons, deals, and/or other forms of promotional banners with higher bid price(s) may be assigned proportionally to members who generate higher number of clicks. Thus, advertisements, content, coupons, deals, and/or other forms of promotional banners with the potential to generate higher revenue are given a better probability of generating more clicks, with the intention of maximizing the revenue generated by the service, as well as the incentives earned by its members. In some embodiments, the server may prioritize advertisement, content, coupon, deal, and/or other forms of promotional banners that generate higher income (Bid price×Clicks/Day).

Furthermore, in some embodiments, the server may choose an advertisement, content, coupon, deal, and/or other form of promotional banner to be displayed on a member's banner placeholder based on one or more the following guidelines/rules: (i) an advertisement, content, coupon, deal, and/or other form of promotional banner's target profile are matched to the member's profile; (ii) an advertisement, content, coupon, deal, and/or other form of promotional banner's target location are matched to the email recipient's location; (iii) an advertisement, content, coupon, deal, and/or other form of promotional banner with a higher bid price or income is given higher priority; and/or (iv) a member who generates higher number of clicks is given higher priority.

Upon receiving the appropriate file for the request, at block 640, the file may be rendered for the recipient to view within the signature block of the electronic message and within the banner placeholder.

In various embodiments, as mentioned, particular advertisements, content, coupons, deals, and/or other forms of promotional banners are dynamically matched to members based on member profiles and/or current advertising campaigns. In some embodiments, a member profile may allow for a user to select categories of advertisement, content, coupon, deal, and other forms of promotional banner that the user wants to display in electronic messages. Conversely, the member profile may allow for the user to select categories that the user does not want to display in electronic messages. Exemplary categories may include, but are not limited to, electronics, furniture, home, beauty, baby, kids, women, men, sports, transportation, clothing, and travel. Through the member profile, the user may select categories of interest and thereby have advertisements, content, coupons, deals, and/or other forms of promotional banner associated with these categories displayed in the electronic messages sent. In one embodiment, if the user finds an advertisement, content, coupon, deal, and/or other form of promotional banner offensive, the user may report the advertisement, content, coupon, deal, and/or other form of promotional banner as inappropriate via a reporting function and have this type or particular advertisement, content, coupon, deal, and/or other form of promotional banner removed. In some embodiments, the particular advertisements, content, coupons, deals and other forms of promotional banners dynamically matched to a member may be based in part of a priority assigned to various advertisements, content, coupons, deals and other forms of promotional banners based on, e.g., a bid price per click.

FIG. 7 is a flow chart illustrating processes 700 for content delivery in response to a user selecting or clicking an advertisement, content, coupon, deal, and/or other form of promotional banner, in accordance with one exemplary embodiment. As mentioned, the advertisement, content, coupon, deal, and/or other form of promotional banner is delivered to and displayed within the signature block of an electronic message. The advertisement, content, coupon, deal, and/or other forms of promotional banner may be constructed from an image (e.g., GIF, JPEG, PNG), a JavaScript program, or a multimedia object employing technologies such as Java, Shockwave, or flash. The advertisement, content, coupon, deal, and/or other form of promotional banner may employ animation, sound, and/or video to maximize presence. The advertisement, content, coupon, deal, and/or other form of promotional banner may be displayed when an electronic message that references the banner is loaded into a web browser.

More specifically and with reference to FIG. 7, a user may select an advertisement, content, coupon, deal, and/or other forms of promotional banner displayed within the signature block on an electronic message at block 710. A hyperlink associated with the advertisement, content, coupon, deal and other forms of promotional banner may include a unique Member ID of a member who initially embedded the advertisement or coupon placeholder into the signature block of the electronic message.

At block 720, a browser associated with the second computing device 150 may send a request to a server (e.g., a web server or an advertisement server) to retrieve a web page. This web page may be a landing page or a lead capture page. In addition the web page may be a reference web page that presents information that is relevant to the visitor, or a transaction web page that seeks to persuade a visitor to complete a transaction such as filling out a form, answering a survey, playing a game, downloading content, interacting with advertisements, content, coupons, deals and other forms of promotional banners of the web page, or purchasing a product or service. The request may be directed to the hyperlink in a <a> tag which contains the an encrypted Member ID.

At block 730, the server receives the request and may identify a member based on the unique Member ID included within the hyperlink. The server may then log the request in a database for future reward or compensation purposes. In particular, the server may identify the user who embedded the banner placeholder by decrypting and validating the Member ID against a list of valid values stored in the server. If the Member ID is invalid, the server may redirect the request to a default web page or landing page, which may be the homepage of the service. The server may identify the recipient of the email message by checking if a Visitor ID was saved with regard to the second computing device. The Visitor ID would have been saved, for example, in Block 630 in FIG. 6 when the email recipient opened the email message. If a Visitor ID was is found or if it does not match any entry from a list of valid values stored in the server, the request is not counted as a valid click.

The server may then record the IP address and the country location of the second computing device in the same manner as described above, and determine if there is a valid click based thereon. The server may then identify the browser, email client, platform, and/or email service that the email recipient is using to open the email. If the server determines that such information are invalid, the server may not count this request as a valid click. The server may then, in the same manner as described above, determine if the recipient has previously clicked on the advertisement, content, coupon, deal, and/or other form of promotional banner, as well as determine if the first computing device is the same as the second computing device, and determine based thereon if a request should be counted as a valid click.

At block 740, the server may redirect the browser to a location of the web page (e.g., the location of the advertisement or coupon landing page). At block 750, the browser may receive the web page and render the page on the second computing device 150.

FIG. 8 is a flow chart describing the processes 800 by which an advertiser, sponsor, partner or couponing company may register an advertisement, content, coupon, deal and other forms of promotional banner with the system to begin a campaign, in accordance with one embodiment of the present disclosure.

At block 810, an advertiser registers with the website associated with the service provider 110. At block 820, the advertiser selects a “create campaign” option and begins creating an advertising or couponing campaign. Part of this process may include, uploading advertisement, content, coupon, deal and other forms of promotional banner materials, creating advertisement, content, coupon, deal and other forms of promotional banner materials, setting bid prices per click, defining a campaign period, and/or identifying a target profile type.

At block 830, after the campaign is created, the user may checkout by providing payment for all or part of the services desired 110 (e.g., via PayPal). At block 840, the campaign is implemented and the previously created or uploaded advertisement, content, coupon, deal and other forms of promotional banner may become “live” or available for inclusion in electronic messages generated by users of the service. The advertiser, at block 850, may monitor reports related to the effectiveness of the campaign, and, at block, 860, modify parameters of the campaign if deemed necessary.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented using hardware, software or a combination thereof. When implemented in software, the software code can be executed on any suitable processor or collection of processors, whether provided in a single computer system (“computer”) or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system comprising:
a first server configured to deliver a webpage over a communication network in response to a request, wherein the webpage includes a banner placeholder configured to be copied or downloaded from the webpage;
a first computing device configured to
copy or download the banner placeholder from the webpage,
modify one or more settings of an electronic messaging application such that the banner placeholder is automatically included within a signature block of an electronic message, and
transmit the electronic message including the banner placeholder within the signature block of the electronic message to a second computing device; and
a second computing device configured to
receive and open the electronic message including the banner placeholder within the signature block of the electronic message,
transmit a request for a file associated with the banner placeholder, and
render content associated with the file in the signature block of the electronic message.

2. The system of claim 1, wherein the electronic message is an email message, a short message service (SMS) message, a multimedia message service (MMS) message, an instant message, a blog message, an audio message, a video message, a wall post, a status message, a comment on a site, a microblog message, or a geolocation check-in message.

3. The system of claim 1, wherein the file comprises an advertisement, content, coupon, deal, or promotion.

4. The system of claim 1, wherein the banner placeholder is configured to cause a browser associated with the second computing device to retrieve content from a content management system, a web server, or an advertisement server.

5. The system of claim 1, wherein the banner placeholder comprises one or more HTML tags that each reference content.

6. The system of claim 5, wherein each HTML tag comprises a query string parameter which includes an encrypted member identification.

7. The system of claim 5, wherein each HTML tag does not include scripts or programs configured to be executed on the second computing device.

8. The system of claim 1, wherein a user associated with the first computing device that transmitted the electronic message receives compensation.

9. A method comprising:
accessing a website via a computing device communicating over a communication network, wherein the website is configured to provide a banner placeholder;
copying or downloading the banner placeholder from the website, wherein the banner placeholder comprises one or more HTML tags that each reference content;
modifying one or more settings associated with an electronic messaging application such that the banner placeholder is automatically included with a signature block of an electronic message; and
transmitting the electronic message including the signature block with the banner placeholder included therein.

10. The method of claim 9, wherein the electronic message is an email message, a short message service (SMS) message, a multimedia message service (MMS) message, an instant message, a blog message, an audio message, a video message, a wall post, a status message, a comment on a site, a microblog message, or a geolocation check-in message.

11. The method of claim 9, wherein the banner placeholder is configured to cause a browser to retrieve one of a text file, an image file, an audio file, a video file, or a multimedia file in response to the electronic message being opened.

12. The method of claim 9, wherein the banner placeholder is configured to cause a browser to retrieve an advertisement, coupon, deal, or promotion.

13. The method of claim 9, wherein each HTML tag comprises a query string parameter which includes an encrypted member identification.

14. The method of claim 9, wherein each HTML tag does not include scripts or programs configured to be executed.

15. The method of claim 9, wherein, in response to modifying the one or more settings associated with the electronic messaging application, the banner placeholder is automatically included within the signature block of every electronic message transmitted by the computing device until the one or more settings are further modified.

16. The method of claim 9, wherein compensation is provided for transmitting the electronic message.

17. A method comprising:
providing a website over a communication network in response to a request;
receiving authentication information entered on the website and determining if the authentication information is associated with an authorized user; and
if the authentication information is associated with an authorized user, providing a banner placeholder,
wherein the banner placeholder comprises one or more HTML tags that each reference content.

18. The method of claim 17, wherein the banner placeholder is configured to be copied or downloaded and embedded into a signature block of an electronic message.

19. The method of claim 17, wherein the electronic message is an email message, a short message service (SMS) message, a multimedia message service (MMS) message, an instant message, a blog message, an audio message, a video message, a wall post, a status message, a comment on a site, a microblog message, or a geolocation check-in message.

20. The method of claim 17, wherein the banner placeholder is an advertisement banner placeholder.

21. The method of claim 17, wherein the banner placeholder is a coupon or deal banner placeholder.

22. The method of claim 17, wherein the banner placeholder is a content banner placeholder.

23. The method of claim 17, wherein the banner placeholder is a promotional banner placeholder.

24. The method of claim 17, wherein the banner placeholder is configured to cause a browser to retrieve one of a text file, an image file, an audio file, a video file, or a multimedia file in response to the electronic message being opened.

25. The method of claim 17, wherein each HTML tag comprises a query string parameter which includes an encrypted member identification.

26. The method of claim 17, wherein each HTML tag does not include scripts or programs configured to be executed on the second computing device.

27. A non-transitory computer-readable medium having instructions stored thereon, the instructions comprising:
instructions for providing a website over a communication network in response to a request;
instructions for receiving authentication information entered on the website and determining if the authentication information is associated with an authorized user; and
instructions for, if the authentication information is associated with an authorized user, providing a banner placeholder,
wherein the banner placeholder comprises one or more HTML tags that each reference content.

28. The non-transitory computer-readable medium of claim 27, wherein the banner placeholder is configured to be copied or downloaded and embedded into a signature block of an electronic message.

29. The non-transitory computer-readable medium of claim 27, wherein the electronic message is an email message, a short message service (SMS) message, a multimedia message service (MMS) message, an instant message, a blog message, an audio message, a video message, a wall post, a status message, a comment on a site, a microblog message, or a geolocation check-in message.

30. The non-transitory computer-readable medium of claim 27, wherein the banner placeholder is an advertisement banner placeholder.

31. The non-transitory computer-readable medium of claim 27, wherein the banner placeholder is a coupon or deal banner placeholder.

32. The non-transitory computer-readable medium of claim 27, wherein the banner placeholder is a content banner placeholder.

33. The non-transitory computer-readable medium of claim 27, wherein the banner placeholder is a promotional banner placeholder.

34. The non-transitory computer-readable medium of claim 27, the banner placeholder is configured to cause a browser to retrieve one of a text file, an image file, an audio file, a video file, or a multimedia file in response to the electronic message being opened.

35. The non-transitory computer-readable medium of claim 27, wherein each HTML tag comprises a query string parameter which includes an encrypted member identification.

36. A method comprising:
receiving, at a server, a file request, wherein the file request includes a unique member identification obtained from a banner placeholder included within a signature block of an electronic message;
determining, based on the unique member identification, an advertisement, content, coupon, deal, or promotion appropriate for the file request; and
causing a file associated with the advertisement, content, coupon, deal, or promotion to be transmitted, wherein the file is rendered in the banner placeholder included within the signature block of the electronic message.

37. The method of claim 36, wherein the electronic message is an email message, a short message service (SMS) message, a multimedia message service (MMS) message, an instant message, a blog message, an audio message, a video message, a wall post, a status message, a comment on a site, a microblog message, or a geolocation check-in message.

38. The method of claim 36, wherein the file is one of a text file, an image file, an audio file, a video file, or a multimedia file.

39. The method of claim 36, wherein the banner placeholder comprises one or more HTML tags that each reference content.

40. A non-transitory computer-readable medium having instructions stored thereon, the instructions comprising:
instructions for receiving a file request, wherein the file request includes a unique member identification obtained from a banner placeholder included within a signature block of an electronic message;
instructions for determining, based on the unique member identification, an advertisement, content, coupon, deal, or promotion for the file request; and
instructions for causing a file associated with the advertisement, content, coupon, deal, or promotion to be transmitted, wherein the file is rendered in the banner placeholder included within the signature block of the electronic message.

41. The non-transitory computer-readable medium of claim 40, wherein the electronic message is an email message, a short message service (SMS) message, a multimedia message service (MMS) message, an instant message, a blog message, an audio message, a video message, a wall post, a status message, a comment on a site, a microblog message, or a geolocation check-in message.

42. The non-transitory computer-readable medium of claim 40, wherein the file is one of a text file, an image file, an audio file, a video file, or a multimedia file.

43. The non-transitory computer-readable medium of claim 40, wherein the banner placeholder comprises one or more HTML tags that each reference content.
